(19) United States
(12) Patent Application Publication
(10) Pub. No.: US 2013/0010282 A1
(43) Pub. Date: Jan. 10, 2013

(54) ILLUMINANCE DISTRIBUTION DETECTION METHOD IN EXTREME ULTRAVIOLET LIGHT SOURCE APPARATUS AND POSITIONING METHOD OF LIGHT FOCUSING OPTICAL MEANS

(75) Inventor: Daiki Yamatani, Shizuoka (JP)

(73) Assignee: USHIO DENKI KABUSHIKI KAISHA, Tokyo (JP)

(21) Appl. No.: 13/636,090

(22) PCT Filed: Mar. 2, 2011
(86) PCT No.: PCT/JP2011/054757

§ 371 Date: Sep. 19, 2012

(30) Foreign Application Priority Data
Mar. 19, 2010 (JP) 2010-064016

(51) Int. Cl. G01N 21/33; G01B 11/14

(52) U.S. Cl. 356/51; 356/614

(57) ABSTRACT

A method of detecting an illuminance distribution of light emitted by an extreme ultraviolet (“EUV”) light source apparatus that includes a light condensing optical means. EUV light that is condensed to a condensing point is passed through a detector that is disposed around an optical axis without being detected, and is guided to an exposure unit. EUV light that is not condensed at the middle condensing point and is not guided to the exposure unit is detected by the detector. The illuminance distribution of the light that is not condensed at the middle condensing point is thereby obtained. The illuminance distribution of the light that is condensed at the middle condensing point may be determined, based on a correlation between the illuminance distribution of the light that is not condensed at the middle condensing and the illuminance distribution of the light that is condensed at the middle condensing point.

### TECHNICAL FIELD

The present invention relates to an illuminance distribution detection method in an extreme ultraviolet (“EUV”) light source apparatus, which emits ultraviolet light, and a positioning method of a light focusing optical means used for an EUV light source apparatus.

### BACKGROUND ART

As semiconductor integrated circuits become microminiaturized and more highly integrated, shortening the wavelength of an exposure light source that is used in manufacturing the circuits is necessary, and an extreme ultraviolet light source apparatus (hereinafter also referred to as an EUV light source apparatus), which emits extreme ultraviolet light (hereinafter referred to as EUV (Extreme Ultra Violet) light) having a wavelength of 13-14 nm, especially a wavelength of 13.5 nm, has been developed (for example, refer to Patent Document 1) as a next generation exposure light source for semiconductors.

FIG. 6 is a diagram for simplified explanation of the EUV light source apparatus disclosed in the Patent Document 1.

As shown in the figure, the EUV light source apparatus has a chamber 1, which is an electric discharge container. In the chamber 1, an electric discharge part 1a, in which a pair of disc-shaped electric discharge electrodes 2a and 2b is accommodated, and an EUV light collecting part 1b, in which a foil trap 5 and a collector mirror 6 are accommodated.

The pair of disc-shaped electrodes 2a and 2b is arranged in upper and lower parts as shown in FIG. 6, so that insulation material 2c is located therebetween. A rotation axis 2e of a motor 2j is attached to the electric discharge electrode 2b, which is located at a lower portion as shown in FIG. 6.

The electric discharge electrodes 2a and 2b are connected to a pulse power supplying unit 3 through sliding elements 2g and 2h. A groove portion 2d is formed in a peripheral portion of the electric discharge electrode 2b, and solid material M (Li or Sn) for generating a high temperature plasma P is arranged in this groove portion 2d.

A gas discharge unit, which discharges gas from the electric discharge part 1a and the EUV light collecting part 1b, thereby forming a vacuum stage in the inside of the chamber 1 is referred to as 1c.

In the EUV light source apparatus, the material for a high temperature plasma, which is arranged at the groove portion of the electric discharge electrode 2b, is irradiated with an energy beam from an energy beam radiation device 4. The energy beam is, for example, a laser beam, and is emitted therefrom through the laser incident window 4a, and the solid material evaporates between the electric discharge electrodes 2a and 2b.

In this state, when pulse power is supplied between the electric discharge electrodes 2a and 2b from the pulse power supplying unit 3, electric discharge occurs between an edge part of the electric discharge electrode 2a and an edge part of the electric discharge electrode 2b, so that plasma P is formed by the high temperature plasma material M, whereby it is heated and excited by large current, which flows at the time of electric discharge, and EUV light is emitted from this high temperature plasma P.

The emitted EUV light enters the EUV light collecting part 1b through a foil trap 5, is condensed at a middle condensing point f of a collector mirror 6 by the collector mirror 6, is emitted from an EUV light emitting mouth 7, and enters an exposure device 40 shown by dotted lines, which is connected to the EUV light source apparatus.

### CITATION LIST

### Patent Literature

Patent Document 1: WO2005/101924

### SUMMARY OF THE INVENTION

### Technical Problem to be Solved by the Invention

However, there was a practical problem in such an EUV light source apparatus, as set forth below.

That is, when the EUV light source apparatus is driven for lighting over a long time, the plasma P and the collector mirror 6 are shifted from each other in alignment thereof, and the property of illuminance distribution is deteriorated at or beyond the middle condensing point f, so that there is a problem that the distribution becomes asymmetrical. Causes set forth below are thought for the deterioration of the property of the illuminance distribution, in which, for example, the illuminance distribution becomes asymmetrical.

(1) When the electric discharge electrodes are worn out with the passage of lighting drive time, the position of the plasma formed between the electric discharge electrodes changes from that in a state in an early stage of lighting.

(2) The collector mirror 6 becomes high in temperature due to heat radiated from the electric discharge electrodes 2a and 2b or the plasma P, whereby heat strain is produced so that it is deformed. Thus, when the property of illuminance distribution of extreme ultraviolet light is deteriorated at or beyond the middle condensing point so that it becomes asymmetrical, uneven exposure may arise on a workpiece, which is treated by an exposure unit 40.

However, in the extreme ultraviolet light source apparatus of prior art, it was not detected in real time during exposure that the property of illuminance distribution of the extreme ultraviolet light at or beyond such a middle condensing point is deteriorated so that the distribution thereof becomes asymmetrical.

In view of the above background, it is an object of the present invention to detect, in real time, that the property of illuminance distribution at or beyond a middle condensing point of an extreme ultraviolet light source apparatus is deteriorated so that the illuminance distribution becomes asymmetrical, and to enable correction of the deteriorated illuminance distribution.

### Solution Measure to Solve the Problem

Since a plasma, from which EUV light is emitted, has a spatial expanse, in an EUV light source apparatus according to the present invention, even if the EUV light is emitted from the plasma and reflected by a collector mirror, not all the reflected EUV light is condensed at a middle condensing point of an EUV light source apparatus. The light, which is not condensed at the middle condensing point, is illuminated onto a circumference of the middle condensing point, and is not guided to the exposure unit.

However, the illuminance distribution of the light, which is condensed at the middle condensing point and enters the exposure unit, and the illuminance distribution of the light, which is not condensed at the middle condensing point, have strong correlation. Therefore, by receiving the EUV light, which is not condensed at the middle condensing point, and detecting the illuminance distribution thereof, it is possible to know the illuminance distribution of the EUV light, which enters the inside of the exposure unit.

Moreover, the deteriorated illuminance distribution can be corrected by performing a position adjustment of a light focusing optical means, based on the illuminance distribution detected from the EUV light, which is not condensed at the middle condensing point.

### Advantageous Effects of Invention

Advantageous effects set forth below can be acquired according to the present invention.

(1) Since the illuminance distribution of the EUV light, which is not condensed at the middle condensing point, is detected, it is not necessary to provide a detection unit in the optical path of EUV light. For this reason, even if the property of illuminance distribution of the extreme ultraviolet light changes due to various factors, it is possible to know, in real time without stopping an operation of the exposure unit during exposure, a fluctuation of the property of illuminance distribution of the extreme ultraviolet light, which is condensed at the middle condensing point and enters the exposure unit.

(2) When the property of illuminance distribution of the extreme ultraviolet light changes, a position adjustment of the light focusing optical means is performed in real time during exposure, so that it is possible to obtain the optimal illuminance distribution property of the extreme ultraviolet light.

### BRIEF DESCRIPTION OF DRAWINGS

FIG. 1 It is a diagram showing a schematic structure of an EUV light source apparatus according to an embodiment of the present invention.

FIG. 2 It is a diagram showing a configuration example of a detection unit for detecting EUV light, which is not condensed at a middle condensing point.

FIG. 3 It is a diagram showing correlation of the illuminance distribution of EUV light condensed at a middle condensing point f, and the illuminance distribution of EUV light, which is not condensed at the middle condensing point f.

FIG. 4 It is a diagram for explaining light, which is not condensed at a condensing point among light beams reflected by a collector mirror.

FIG. 5 It is a diagram showing a schematic structure where the present invention is applied to an EUV light source apparatus, in which no electric discharge electrode is provided.

FIG. 6 It is a diagram explaining an EUV light source apparatus.

### DESCRIPTION OF EMBODIMENTS

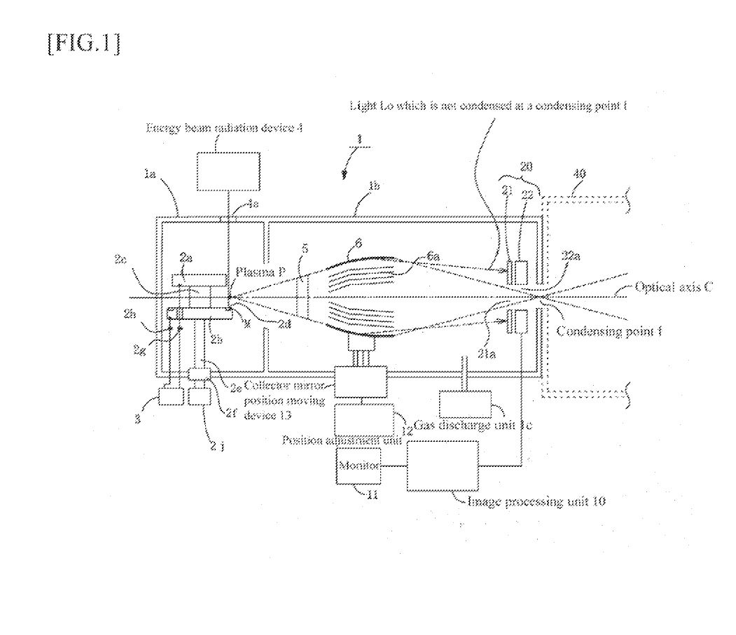

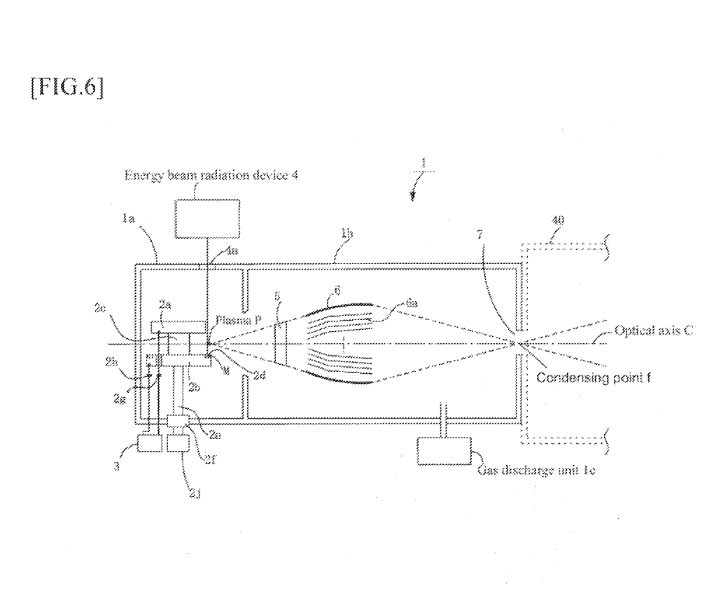

FIG. 1 is a diagram showing a schematic structure of an EUV light source apparatus according to an embodiment of the present invention. The structure of the EUV light source apparatus is the same as that shown in FIG. 6, and comprises a chamber 1 made up of an electric discharge part 1a, which accommodates electric discharge electrodes 2a and 2b, and an EUV light collecting part 1b, which accommodates a foil trap 5 and a collector mirror (light focusing optical means) 6.

A gas discharge unit 1c for discharging air in the electric discharge part 1a and the EUV light collecting part 1b thereby forming a vacuum state inside the chamber 1 is provided in the chamber 1.

The pair of disc-shaped electric discharge electrodes 2a and 2b is arranged so as to face each other with an insulating member 2c interposed therebetween, and each center thereof is arranged on the same axis.

A rotation axis 2e of a motor 2j is attached to the electric discharge electrode 2b located on a lower part side in the drawing. As to the rotation axis 2e, the center of the electric discharge electrode 2a and the center of the electric discharge electrode 2b are located on the same axis of the rotation axis 2e. The rotation axis 2e is installed in the chamber 1 through a mechanical seal 2f.

The mechanical seal 2f permits rotation of the rotation axis 2e, while maintaining the reduced-pressure atmosphere in the chamber 1.

Sliding elements 2g and 2h, which are made up of, for example, carbon brushes etc. are provided in a lower part side of the electric discharge electrode 2b. The sliding element 2g is electrically connected to the electric discharge electrode 2a through a through-hole formed in the electric discharge electrode 2b. The sliding element 2h is electrically connected to the electric discharge electrode 2b.

A pulse power supplying unit 3 supplies pulse power to the electric discharge electrodes 2a and 2b through the sliding elements 2g and 2h, respectively.

A peripheral portion of each of the disc-shaped electric discharge electrodes 2a and 2b is form in an edge shape.

Solid or liquid material M for generating a high temperature plasma is arranged at a groove portion 2d of the electric discharge electrode 2b. The material M is, for example, tin (Sn), or lithium (Li).

If electric power is supplied to the electric discharge electrodes 2a and 2b from the pulse power supplying unit 3, electric discharge occurs between the edge parts of both electrodes 2a and 2b.

Since the peripheral portions of the electric discharge electrodes 2a and 2b become higher in temperature by the electric discharge when the electric discharge occurs, the electric discharge electrodes 2a and 2b are made of high melting point metal such as tungsten, molybdenum, and tantalum etc.

The insulating member 2c is made up of silicon nitride, aluminium nitride, diamond, etc. in order to secure insulation between the electric discharge electrodes 2a and 2b.

An energy beam radiation device 4 for evaporating the material M by irradiating the material M with an energy beam is provided in the chamber 1. The energy beam emitted from the energy beam radiation device 4 is, for example, a laser beam.

The material M for a high temperature plasma arranged at the groove portion 2d of the electric discharge electrode 2b is irradiated with the laser beam emitted through a laser incident window 4a from the energy beam radiation device 4. Thereby, the material M is evaporated between the electric discharge electrodes 2a and 2b. When pulse power is supplied from the pulse power supplying unit 3 between the electric discharge electrodes 2a and 2b in this status, electric discharge occurs between the edge part of the electric discharge electrode 2a and the edge part of the electric discharge electrode 2b. The large current that flows during the electric discharge raises the temperature of the material M, and a plasma P is formed by the high temperature plasma material M, resulting in heating excitation, whereby EUV light is emitted from this high temperature plasma P.

The foil trap 5 arranged in the EUV light collecting part 1b, is provided, in order to suppress debris, which is generated from the substance which forms the electric discharge electrodes or the material M for generating a high temperature plasma, from scattering towards the collector mirror 6. Two or more small spaces divided by two or more thin boards which radially extend, are formed in the foil trap 5.

Light reflecting faces 6a for reflecting EUV light with a wavelength of 13.5 nm emitted from the high temperature plasma are formed in the collector mirror 6 arranged in the EUV light collecting part 1b.

The light condensing reflection mirror 6 comprises two or more light reflecting faces 6a, which are arranged in a nested fashion without contacting each other.

Each light reflecting face 6a is formed so as to make good reflection of extreme ultraviolet light whose incidence angle is 0-25 degrees, by precisely coating metal such as Ru (ruthenium), Mo (molybdenum), Rh (rhodium) etc., on a reflective face side of the base substance material which has a smooth face made of Ni (nickel) etc. The light reflecting faces 6a are formed so that condensing point f thereof may be in agreement with one another.

It is an object in the EUV light source apparatus according to the present invention, to obtain an illuminance distribution change of the EUV light at or beyond the condensing point (middle condensing point) f of the EUV light source apparatus.

That is, since the light, which passes through the middle condensing point f, enters the exposure unit 40 connected to the EUV light source apparatus, uneven exposure is prevented from occurring on a workpiece on which exposure processing is performed by the exposure unit 40, by acquiring the illuminance distribution change of the illuminance of the EUV light at or beyond the middle condensing point f.

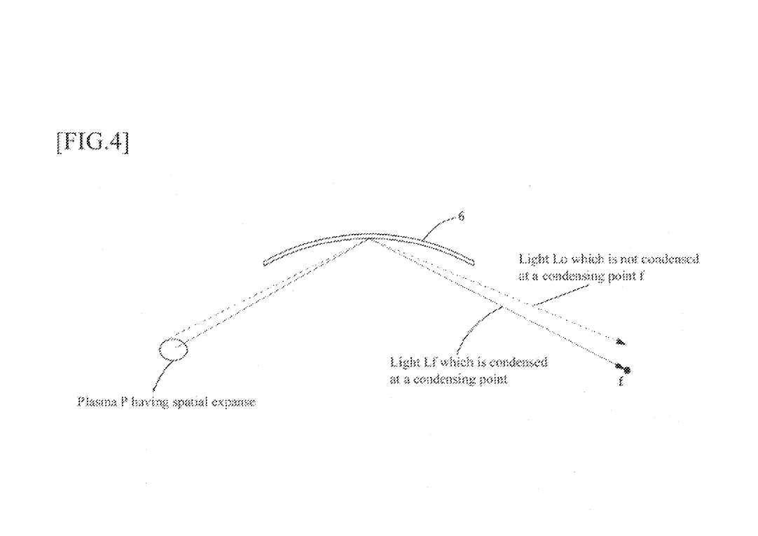

Since, in the EUV light source apparatus, a plasma, which is formed between the pair of electric discharge electrodes, has a spatial expanse, as shown in FIG. 4, even if EUV light is emitted from the plasma and is reflected by the reflective face 6a of the collector mirror 6, not all of the reflected EUV light is condensed at the middle condensing point f, so that there is light Lo, which is not condensed at the middle condensing point f, i.e., a component, which is illuminated on a circumference of the middle condensing point f.

Accordingly, in the present invention, in order to detect a illuminance distribution change of the EUV light, which is condensed at the middle condensing point f and enters the exposure unit, consideration is made for a measurement of the property of illuminance distribution of the light Lo, which is not condensed at the middle condensing point f, that is, EUV light, illuminated on a circumference of the middle condensing point f, rather than that of the EUV light Lf, which is condensed at the middle condensing point f.

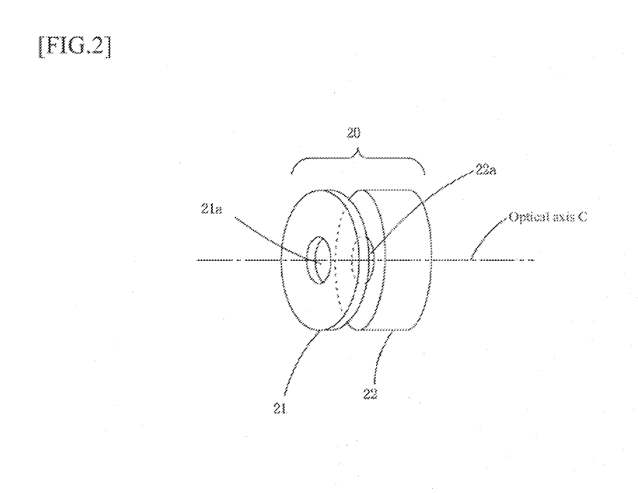

Description of a detection unit for detecting the EUV light, which is not condensed at the middle condensing point f, will be given below, referring to FIGS. 1 and 2.

As shown in FIG. 1, the detection unit 20 for detecting the EUV light that is not condensed at the middle condensing point f is arranged around an optical axis C of the collector mirror 6, between the collector mirror 6 and the condensing point f (middle condensing point) of the collector mirror 6.

And while the detection unit 20 has a light receiving unit for receiving EUV light that is illuminated on a circumference of the middle condensing point f and for obtaining an illuminance distribution image thereof, it has a cylinder shape having openings 21a and 22a, through which the EUV light condensed at the middle condensing point f passes.

That is, since the EUV light that is condensed at the middle condensing point f and enters the exposure unit passes through these openings 21a and 22a, the detection unit 20 can detect the EUV light that is not condensed at the middle condensing point f even if the apparatus is in the midst of exposure processing (during an operation of the exposure unit).

FIG. 2 is a perspective view of the detection unit 20, which is viewed from a collector mirror side. The detection unit 20 has the light receiving unit 21 that is irradiated with EUV light that is not condensed at the condensing point f, and the detection unit 22 for detecting the intensity of the light from the light receiving unit 21.

The light receiving unit 21 is a scintillator, and converts the irradiated EUV light into visible light. The light receiving unit 21 has a face, which receives the EUV light illuminated on a circumference of the middle condensing point f, and has an opening 21a through which the EUV light to be condensed at the middle condensing point f passes.

The detection unit 22 is a CCD, which receives light converted into the visible light by the light receiving unit 21, and transmits the received illuminance data as an electric signal to the image processing unit 10. The detection unit 22 has a face, which receives the visible light converted by the light receiving unit 21, and has an opening 22a, through which the EUV light to be condensed at the middle condensing point f passes.

For example, a unit, in which two or more light receiving units are arranged around the middle condensing point f, may be used as the detection unit 20, as long as it receives EUV light illuminated on a circumference of the middle condensing point f and it can obtain illuminance distribution.

The image processing unit 10 can obtain the illuminance distribution of the EUV light, which is not condensed at the middle condensing point f of the EUV light source apparatus by performing image processing based on illuminance distribution data received from the detection unit 20.

The illuminance distribution of the EUV light that is not condensed at the middle condensing point f, wherein the illuminance distribution has been obtained by the image processing unit 10, is displayed on, for example, a monitor 11. Moreover, a collector mirror position moving device 13 for moving the collector mirror 6 is provided on the collector mirror 6, and the collector mirror position moving device 13 is driven by a position adjusting unit 12.

Since the illuminance distribution of the EUV light that is not condensed at the middle condensing point f, wherein it has been obtained as described above, has correlation with the illuminance distribution of the EUV light that is condensed at the condensing point f and enters the exposure unit, as described above, it is possible to know the deterioration of the illuminance distribution of the EUV light that is condensed at the condensing point f and enters the exposure unit, from the deterioration of the illuminance distribution of the EUV light obtained by the detection unit 20.

Therefore, if the illuminance distribution displayed on the monitor 11 is getting worse compared with the initial illuminance distribution measured in advance, a collector mirror moving unit 14 is driven by the collector mirror position adjusting unit 13, so that the position of the collector mirror 6 can be corrected.

That is, the collector mirror moving unit 14 is driven by the collector mirror position adjusting unit 13 thereby moving the collector mirror 6 so that the illuminance distribution of the EUV light that is not condensed at the middle condensing point f of the EUV light source apparatus may become good, whereby the illuminance distribution of the EUV light that is condensed at the condensing point f and enters the exposure unit is also improved.

As described, above, even if the detection unit 20 is under exposure processing (during an operation of the exposure unit 40), it is possible to detect the EUV light that is not condensed at the middle condensing point f, and since the EUV light that is condensed at the middle condensing point f is not blocked, it is possible to, in real time, know the deterioration of the illuminance distribution of the EUV light that enters the exposure unit. It is also possible to, in real time, correct illuminance distribution fluctuations of the EUV light by moving the collector mirror 6 in response thereto.

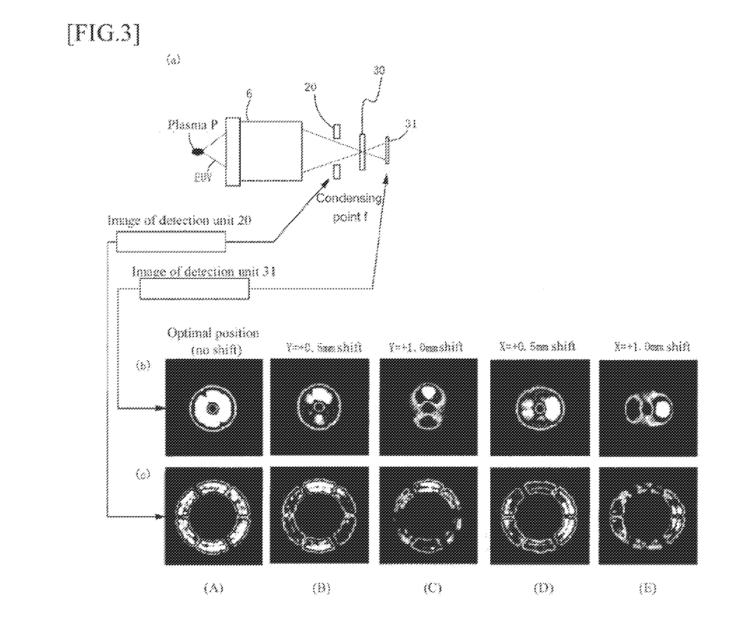

FIG. 3 is a diagram showing correlation of the illuminance distribution of the EUV light condensed at a middle condensing point f, and the illuminance distribution of the EUV light that is not condensed at the middle condensing point f.

As shown in (a) of the figure, an aperture 30 is arranged at the middle condensing point f of the EUV light, the detection unit 20 (as shown in FIG. 2), which has an opening at the center thereof and which measures the illuminance distribution, is arranged on a collector mirror 6 side of the middle condensing point f at which the aperture 30 is arranged, and a detection unit 31 for measuring the illuminance distribution of EUV light is arranged at a predetermined position at or beyond the middle condensing point f (an opposite side of the collector mirror 6 with respect to the middle condensing point). Illuminance distributions of EUV light that is not condensed at the middle condensing point f and illuminance distributions of EUV light that is condensed at the middle condensing point were measured.

FIG. 3 (b) shows the illuminance distribution of the EUV light that is condensed at the middle condensing point f, and (c) shows the illuminance distribution of the EUV light that is not condensed at the middle condensing point f. A white portion shows the intensity of EUV light is high, and gray to black portions show the intensity of EUV light is low.

FIG. 3(b)(A) shows a case where the illuminance distribution of the EUV light that is condensed at the middle condensing point f is optimal, as the white portion spreads uniformly and entirely.

Also in the illuminance distribution of the EUV light that is not condensed by the middle condensing point f corresponding to this case, as shown in (A) of FIG. 3 (c), the white portion spreads uniformly and entirely (black portions which divide the whole into six are the shadow of a support member for supporting each reflective face 6a of the collector mirror 6).

(B) and (C) of FIG. 3 (b) show cases where, in the illuminance distribution of the EUV light that is condensed at the middle condensing point f, the intensity of the EUV light is high on an upper side of the drawing. As shown in (B) and (C) of FIG. 3 (c), in the corresponding cases showing the illuminance distribution of the EUV light that is not condensed at the middle condensing point f, the intensity of the EUV is also high on an upper side in the drawing.

(D) and (E) of FIG. 3 (b) show cases where the intensity of the EUV is high on a right side of the drawing, in the illuminance distribution of the EUV light that is condensed at the middle condensing point f. As shown in (D) and (E) of FIG. 3 (c), in the corresponding cases showing the illuminance distribution of the EUV light that is not condensed at the middle condensing point f, the intensity of the EUV is also high on a right side in the drawing.

Thus, it turns out that there is a correlation since the illuminance distribution of the EUV light that is not condensed at the middle condensing point f is similarly shown as in the illuminance distribution of the EUV light that is condensed at the middle condensing point f.

Therefore, it is possible to know the illuminance distribution of the EUV light that is condensed at the middle condensing point f by detecting the illuminance distribution of the EUV light that is not condensed at the middle condensing point f, by the detection medium 20, and in addition, if the position of the collector mirror 6 is adjusted so that the illuminance distribution of the EUV light that is not condensed at the middle condensing point f, may become uniform, the illuminance distribution of the EUV light that is condensed at the middle condensing point f can also be made uniform.

In addition, it is thought that if the collector mirror 6 is moved and the relative position relationship thereof with the foil trap 5 is changed, the difference in the position relationship of both of them influences the illuminance distribution. Therefore, when the reflective collector mirror 6 is moved, it is desirable to move the foil trap 5 theretogether. For this purpose, it may be configured so that the reflective collector mirror 6 and the foil trap 5 may be connected and fixed to each other.

Moreover, a position adjustment of the collector mirror 6 based on detection of the illuminance distribution of the EUV light that is not condensed at the middle condensing point f, can be used for a position adjustment of the collector mirror 6 at the time of replacement of the collector mirror 6 with a new one.

In addition, out-of-band light whose wavelength is longer than the EUV light, which has wavelength of 13.5 nm, is also emitted from a plasma, and enters the light receiving unit 21. The illuminance distribution of the out-of-band light may differ sometimes from the illuminance distribution of the EUV light. Therefore, if much out-of-hand light is illuminated on the light receiving unit 21, the illuminance distribution of the EUV light may not be exactly obtained.

Therefore, a wavelength selecting element, which transmits only EUV light with wavelength of 13.5 nm, may be arranged on a light incidence side of the light receiving unit 21, so as to irradiate the light receiving unit 21 with only EUV light. Thereby, the influence of the out-of-band light to the illuminance distribution of the EUV light can be reduced.

Although in the above-mentioned embodiment, an example of the EUV light source apparatus that emits EUV light from electric discharge produced between the electric discharge electrodes is explained, there are some EUV light source apparatuses in which electric discharge electrodes are not provided, and a method for adjusting the position of a light condensing reflection mirror according to the present invention may be applied to such apparatuses.

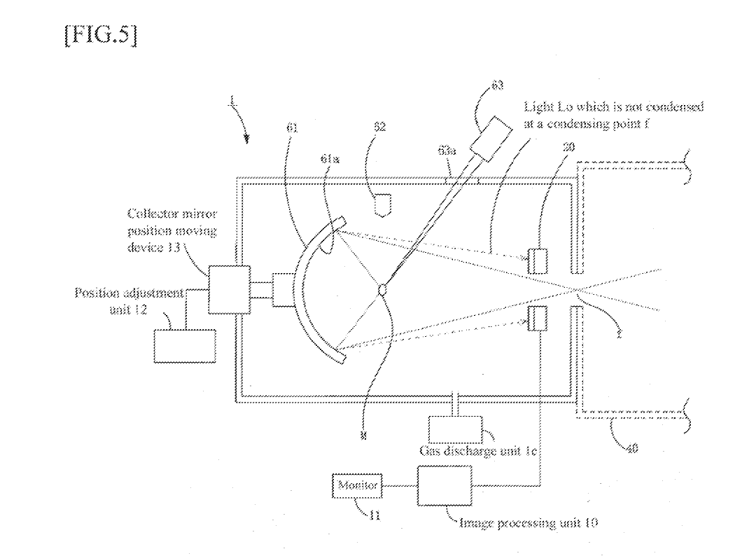

FIG. 5 is a diagram showing a schematic structure where the present invention is applied to an EUV light source apparatus in which no electric discharge electrode is provided.

The EUV light source apparatus has a chamber 1 accommodating a collector mirror 61, which is a light focusing optical means. A light reflecting face 61a, which reflects EUV light with wavelength of 13.5 nm emitted from a high temperature plasma, and condenses that light at the condensing point f, is formed on the collector mirror 61.

The gas discharge unit 1c for forming a vacuum state inside the chamber 1 is provided in the chamber 1.

The EUV light source apparatus is equipped with a material supplying unit 62, which drops (places a drop of) and supplies the liquid or solid material M for high temperature plasma generation, on a light reflecting face 61a side of the collector mirror 61. The material M is, for example, tin (Sn), or lithium (Li).

The EUV light source apparatus has a high output laser apparatus 63, which irradiates the material M supplied by the material supplying unit 62, with a laser beam of very high energy.

A laser beam, which has very high energy, is emitted from a high output laser apparatus 63 to the material M for high temperature plasma supplied to the light reflecting face 61a side of the collector mirror 61 by the material supplying unit 62, through the laser incident window 63a. Thereby, the material M serves as a high temperature plasma, and emits EUV light with wavelength of 13.5 nm. The EUV light emitted from the high temperature plasma is reflected by the light reflecting face 61a of the collector mirror 61 and is condensed at the middle condensing point f.

However, since the generated plasma has a spatial expanse as described above, even if it is emitted from the plasma and is reflected by the collector mirror 61, not all the reflected EUV light is condensed at the middle condensing point f, and thus all the reflected EUV light is not condensed at the middle condensing point f, so that a component thereof, which is illuminated to a circumference of the middle condensing point f, is produced.

Then, similarly to that of the above-mentioned embodiment, a detection medium 20 for detecting EUV light, which is not condensed at the middle condensing point f, is arranged between the collector mirror 61 and the condensing point (the middle condensing point) f of the collector mirror 61 and on the optical axis of the collector mirror 61, and the illuminance distribution of the EUV light, which is not condensed at the middle condensing point f and is emitted to a circumference thereof, is measured.

And the position of the collector mirror 61 is moved based on the measured illuminance distribution of the EUV light, which is not condensed at the middle condensing point f so that fluctuation of the illuminance distribution of the EUV light, which is condensed at the middle condensing point f, is corrected.

### REFERENCE SIGNS LIST

1 Chamber
1a Electric discharge part
1b EUV light collecting part
2a, 2b Electric discharge electrodes
2c Insulating member
3 Pulse power supplying unit
4 Energy beam radiation device
5 Foil trap
6 Condensing mirror
10 Image processing unit
11 Monitor
13 Position adjusting unit
14 Condensing mirror moving unit
20 Detection unit
21 Scintillator
22 CCD
30 Aperture
31 Detection unit
40 Exposure unit
61 Condensing mirror
62 Material supplying unit
63 High output laser device
C Optical axis
Lo Light which is not condensed at a condensing point
Lf Light which is condensed at a condensing point

1. A method for detecting an illuminance distribution in an extreme ultraviolet light source apparatus having a light focusing optical means that reflects and condenses extreme ultraviolet light, comprising the following steps of:
passing light condensed by the light focusing optical means,
receiving, at two or more portions of a circumference of an optical axis, light that is not condensed, and
obtaining the illuminance distribution at a condensing position of the light focusing optical means, based on the illuminance distribution of the that light is not condensed.

2. A method for adjusting a position of a light focusing optical means in an extreme ultraviolet light source apparatus having a light focusing optical means that condenses extreme ultraviolet light, comprising the following steps of:
a first step of measuring a illuminance distribution at between a light collector mirror and a focus point of the light collector mirror, by passing light condensed by the light focusing optical means, and by receiving, at two or more portions of a circumference of an optical axis, the light that is not condensed, and
a second step of moving the light focusing optical means so that the illuminance distribution measured in the first step is uniform.

3. A method for detecting an illuminance distribution in an extreme ultraviolet light source apparatus having a light focusing optical means that reflects and condenses extreme ultraviolet light, comprising the following steps of:
passing light that is condensed to a condensing point by the light focusing optical means past a detector,
detecting in the detector at two or more portions of a circumference of an optical axis, light that is not condensed to the condensing point, and
obtaining the illuminance distribution of the light that is not condensed to the condensing point.

4. The method of claim 3, further comprising the step of determining the illuminance distribution of the light that is condensed to the condensing point based on the illuminance distribution of the light that is not condensed to the condensing point.

5. The method of claim 3, further comprising displaying the illuminance distribution of the light that is not condensed to the condensing point.

6. A method for adjusting a position of a light focusing optical means in an extreme ultraviolet light source apparatus having a light focusing optical means that condenses extreme ultraviolet light using the method of claim 3, further comprising:
moving the light focusing optical means so that the illuminance distribution measured in the first step is uniform.

7. The method of claim 6, wherein the light condensing optical means has fixed thereto a foil trap, such that the foil trap moves in conjunction with the light condensing optical means.
